(19) United States
(12) Patent Application Publication
(10) Pub. No.: US 2026/0205959 A1
(43) Pub. Date: Jul. 16, 2026

(54) CLOSED-LOOP UPLINK POWER CONTROL TECHNIQUES IN WIRELESS COMMUNICATIONS

(71) Applicant: QUALCOMM Incorporated, San Diego, CA (US)

(72) Inventors: Yi HUANG, San Diego, CA (US); Jing SUN, San Diego, CA (US); Linhai HE, San Diego, CA (US); Jing JIANG, San Diego, CA (US); Mostafa KHOSHNEVISAN, San Diego, CA (US)

(21) Appl. No.: 19/021,058

(22) Filed: Jan. 14, 2025

(51) Int. Cl. H04W 52/36; H04W 52/08; H04W 52/14

(52) U.S. Cl. CPC H04W 52/365; H04W 52/08; H04W 52/146

(57) ABSTRACT

Methods, systems, and devices for wireless communications are described for a unified power headroom (PHR) report format that indicates a first quantity of downlink pathloss measurements for a first quantity of configured downlink pathloss reference signals, a second quantity of accumulated closed loop power values for the first quantity of configured power control loops, and an indication of a user equipment (UE) maximum power. The PHR report may be flexibly configured for multiple different pathloss reference signals, and for one or two separate power control loops, and a UE may provide PHR reports in accordance with the configuration.

### FIELD OF TECHNOLOGY

The following relates to wireless communications, including closed-loop uplink power control techniques in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE and transmitting at least the first power headroom report in accordance with the configuration information.

A UE for wireless communications is described. The UE may include one or more memories storing processor executable code, and one or more processors coupled with the one or more memories. The one or more processors may individually or collectively be operable to execute the code to cause the UE to receive configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE and transmit at least the first power headroom report in accordance with the configuration information.

Another UE for wireless communications is described. The UE may include means for receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE and means for transmitting at least the first power headroom report in accordance with the configuration information.

A non-transitory computer-readable medium storing code for wireless communications is described. The code may include instructions executable by one or more processors to receive configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE and transmit at least the first power headroom report in accordance with the configuration information.

In some examples of the method, UEs, and non-transitory computer-readable medium described herein, a first power control loop of the second quantity of power control loops provides a first closed loop power control function for each of a first set of uplink shared channel transmissions, a first set of uplink control channel transmissions, and a first set of uplink sounding reference signal transmissions and a second power control loop of the second quantity of power control loops provides a second closed loop power control function for each of a second set of uplink shared channel transmissions, a second set of uplink control channel transmissions, and a second set of uplink sounding reference signal transmissions. In some examples of the method, UEs, and non-transitory computer-readable medium described herein, the configuration information further indicates that one or both of the first power control loop or the second power control loop are enabled at the UE.

Some examples of the method, UEs, and non-transitory computer-readable medium described herein may further include operations, features, means, or instructions for measuring a downlink pathloss for each pathloss reference signal of the first quantity of pathloss reference signals, where each pathloss reference signal is associated with one or more of an uplink shared channel, an uplink control channel, an uplink sounding reference signal, or a random access channel, and where the first power headroom report includes a measured downlink pathloss for each pathloss reference signal.

Some examples of the method, UEs, and non-transitory computer-readable medium described herein may further include operations, features, means, or instructions for determining the second quantity of accumulated closed loop power values associated with each power control loop of the second quantity of power control loops as a sum of received power increment values and power decrement values received in one or more transmit power control commands associated with each respective power control loop.

In some examples of the method, UEs, and non-transitory computer-readable medium described herein, the first power headroom report includes information for each of the first quantity of pathloss measurements, the second quantity of accumulated closed loop power values, and the maximum transmit power of the UE.

In some examples of the method, UEs, and non-transitory computer-readable medium described herein, the first power headroom report indicates each of the first quantity of pathloss measurements and the method, apparatuses, and non-transitory computer-readable medium may include further operations, features, means, or instructions for transmitting a second power headroom report in accordance with the configuration information that indicates the second quantity of accumulated closed loop power values and transmitting a third power headroom report in accordance with the configuration information that indicates the maximum transmit power of the UE. In some examples of the method, UEs, and non-transitory computer-readable medium described herein, the first power headroom report, the second power headroom report, and the third power headroom report may be transmitted at different periodicities.

Some examples of the method, UEs, and non-transitory computer-readable medium described herein may further include operations, features, means, or instructions for receiving a trigger to transmit the first power headroom report, and where the first power headroom report is transmitted in response to the trigger. In some examples of the method, UEs, and non-transitory computer-readable medium described herein, receiving the trigger to transmit the first power headroom report may include operations, features, means, or instructions for detecting that a parameter value associated with the first power headroom report has changed from a prior reported value by a threshold amount.

A method for wireless communications by a network entity is described. The method may include outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE, obtaining at least the first power headroom report in accordance with the configuration information, and outputting control information for one or more uplink transmissions of the UE that includes a power control parameter that is based on the first power headroom report.

A network entity for wireless communications is described. The network entity may include one or more memories storing processor executable code, and one or more processors coupled with the one or more memories. The one or more processors may individually or collectively be operable to execute the code to cause the network entity to output configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE, obtain at least the first power headroom report in accordance with the configuration information, and output control information for one or more uplink transmissions of the UE that includes a power control parameter that is based on the first power headroom report.

Another network entity for wireless communications is described. The network entity may include means for outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE, means for obtaining at least the first power headroom report in accordance with the configuration information, and means for outputting control information for one or more uplink transmissions of the UE that includes a power control parameter that is based on the first power headroom report.

A non-transitory computer-readable medium storing code for wireless communications is described. The code may include instructions executable by one or more processors to output configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE, obtain at least the first power headroom report in accordance with the configuration information, and output control information for one or more uplink transmissions of the UE that includes a power control parameter that is based on the first power headroom report.

In some examples of the method, network entities, and non-transitory computer-readable medium described herein, a first power control loop of the second quantity of power control loops provides a first closed loop power control function for each of a first set of uplink shared channel transmissions, a first set of uplink control channel transmissions, and a first set of uplink sounding reference signal transmissions and a second power control loop of the second quantity of power control loops provides a second closed loop power control function for each of a second set of uplink shared channel transmissions, a second set of uplink control channel transmissions, and a second set of uplink sounding reference signal transmissions. In some examples of the method, network entities, and non-transitory computer-readable medium described herein, the configuration information further indicates that one or both of the first power control loop or the second power control loop are enabled at the UE.

In some examples of the method, network entities, and non-transitory computer-readable medium described herein, the first power headroom report includes a measured a downlink pathloss for each pathloss reference signal of the first quantity of pathloss reference signals, where each pathloss reference signal is associated with one or more of an uplink shared channel, an uplink control channel, an uplink sounding reference signal, or a random access channel.

In some examples of the method, network entities, and non-transitory computer-readable medium described herein, the second quantity of accumulated closed loop power values are associated with each power control loop of the second quantity of power control loops, and indicate a sum of power increment values and power decrement values provided to the UE in one or more transmit power control commands associated with each respective power control loop.

In some examples of the method, network entities, and non-transitory computer-readable medium described herein, the first power headroom report includes information for each of the first quantity of pathloss measurements, the second quantity of accumulated closed loop power values, and the maximum transmit power of the UE.

In some examples of the method, network entities, and non-transitory computer-readable medium described herein, the first power headroom report indicates each of the first quantity of pathloss measurements and the method, apparatuses, and non-transitory computer-readable medium may include further operations, features, means, or instructions for obtaining a second power headroom report in accordance with the configuration information that indicates the second quantity of accumulated closed loop power values and obtaining a third power headroom report in accordance with the configuration information that indicates the maximum transmit power of the UE. In some examples of the method, network entities, and non-transitory computer-readable medium described herein, the first power headroom report, the second power headroom report, and the third power headroom report may be transmitted at different periodicities.

Some examples of the method, network entities, and non-transitory computer-readable medium described herein may further include operations, features, means, or instructions for configuring a trigger for the UE to transmit the first power headroom report, and where the first power headroom report is transmitted in response to the trigger. In some examples of the method, network entities, and non-transitory computer-readable medium described herein, the trigger includes a parameter value associated with the first power headroom report that has changed from a prior reported value by a threshold amount.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports closed-loop uplink power control techniques in wireless communications in accordance with one or more aspects of the present disclosure.

FIG. 2 shows an example of a wireless communications system that supports closed-loop uplink power control techniques in wireless communications in accordance with one or more aspects of the present disclosure.

FIG. 3 shows an example of a power control channel mapping that supports closed-loop uplink power control techniques in wireless communications in accordance with one or more aspects of the present disclosure.

FIG. 4 shows an example of a process flow that supports closed-loop uplink power control techniques in wireless communications in accordance with one or more aspects of the present disclosure.

FIGS. 5 and 6 show example block diagrams of devices that support closed-loop uplink power control techniques in wireless communications in accordance with one or more aspects of the present disclosure.

FIG. 7 shows an example block diagram of a communications manager that supports closed-loop uplink power control techniques in wireless communications in accordance with one or more aspects of the present disclosure.

FIG. 8 shows an example diagram of a system including a device that supports closed-loop uplink power control techniques in wireless communications in accordance with one or more aspects of the present disclosure.

FIGS. 9 and 10 show example block diagrams of devices that support closed-loop uplink power control techniques in wireless communications in accordance with one or more aspects of the present disclosure.

FIG. 11 shows an example block diagram of a communications manager that supports closed-loop uplink power control techniques in wireless communications in accordance with one or more aspects of the present disclosure.

FIG. 12 shows an example diagram of a system including a device that supports closed-loop uplink power control techniques in wireless communications in accordance with one or more aspects of the present disclosure.

FIGS. 13 through 17 show example flowcharts illustrating methods that support closed-loop uplink power control techniques in wireless communications in accordance with one or more aspects of the present disclosure.

### DETAILED DESCRIPTION

In some systems, a user equipment (UE) may report a power headroom in a power headroom report associated with an amount of power available for uplink transmissions by the UE. A network entity may schedule communications with the UE based on the reported power headroom. The power headroom report may indicate an amount of power available for one or more transmissions by the UE, a difference between the amount of power available and an amount of power currently used by the UE for transmissions, or both. In some wireless communications systems, such as some fifth generation (5G) systems, power headroom may be reported for each of three power headroom types, namely Type 1, Type 2, and Type 3. In such systems, Type 1 may provide power headroom (PHR) for uplink shared channel (e.g., a physical uplink shared channel (PUSCH)) transmissions, Type 2 may provide PHR for concurrent uplink control channel (e.g. physical uplink control channel (PUCCH)) and uplink shared channel (e.g., PUSCH) transmissions, and Type 3 may provide PHR for uplink reference signal (e.g., a sounding reference signal (SRS)) transmissions. Each PHR type in such examples may provide a value for a maximum transmit power of the UE (e.g., P_{CMAX}) and a difference between the maximum transmit power and a current uplink transmit power (e.g., PPUSCH, PPUCCH, or PSRS). Further, in some systems, multiple (e.g., two) power control loops may be maintained for each channel, which may result in a UE tracking multiple (e.g., up to six) loops independently.

In accordance with various aspects discussed herein, techniques are provided for reducing a quantity of power control loops that are independently tracked at a UE, and reducing signaling between a UE and a network entity, which may improve coordination between the UE and the network entity, as well as improve throughput and reliability of uplink communications. In some aspects, separate closed-loop power control loops for multiple uplink channels (e.g., PUSCH, PUCCH, SRS, various combinations thereof) may be consolidated into one or two closed loops (e.g., X closed loops), where each closed loop can be applied for all uplink transmissions. For example, different loops may be configured for uplink control channel formats that support multi-user or single-user transmissions in a same resource block. The closed loops that apply for different channel types can provide reduced latency in power control updates across channel types, which can enhance communications reliability. Further, as indicated, PHR reporting can consume a relatively large amount of overhead associated with multiple PHR types, and techniques, systems, and devices described herein provide for a UE to transmit PHR information according to a unified PHR report format.

In some aspects, the unified PHR report format may provide that a UE can transmit a PHR report that indicates a first quantity (e.g., Y) of downlink pathloss measurements for a first quantity (e.g., Y) of configured downlink pathloss reference signals, a second quantity (e.g., X) of accumulated closed loop power values for the first quantity of configured power control loops, and an indication of the UE P_{CMAX}. In some aspects, the PHR report may be flexibly configured for multiple different pathloss reference signals (e.g., up to four for each of an uplink control channel, an uplink shared channel, an uplink reference signal, and an uplink random access channel such as a physical random access channel (PRACH)), and for one or more separate power control loops. In some aspects, a UE may be configured with a single pathloss reference signal (e.g., a channel state information (CSI) reference signa (RS)), and either one or more power control loops, and thus the unified PHR report format will consume less overhead than traditional PHR reports, and will also provide flexibility for reporting additional details if needed for some scenarios. In some aspects, different uplink channels may be associated with one or more power control loops, which may provide flexible power control configurations. Additionally, or alternatively, a UE may be configured to transmit multiple PHR reports that include different parameters, such as a first PHR report that provides the first quantity of downlink pathloss measurements, a second PHR report that provides the second quantity of accumulated closed loop power values, and a third PHR report that provides P_{CMAX}. In some aspects, the different PHR reports may be transmitted at different periodicities, in accordance with different rates of change for each of the associated values.

Particular aspects of the subject matter described herein may be implemented to realize one or more potential advantages. For example, the described techniques related to a unified PHR report that provides information related to pathloss measurements, accumulated closed loop power values, and maximum transmit power of the UE may provide for enhanced reliability of uplink communications through accurate PHR information, reduced latency, improved user experience, and more efficient utilization of communication resources, among other benefits.

Aspects of the disclosure are initially described in the context of wireless communications systems. Aspects of the disclosure are further illustrated by and described with reference to mappings between uplink channels and power control loops, a process flow, apparatus diagrams, system diagrams, and flowcharts that relate to closed-loop uplink power control techniques in wireless communications.

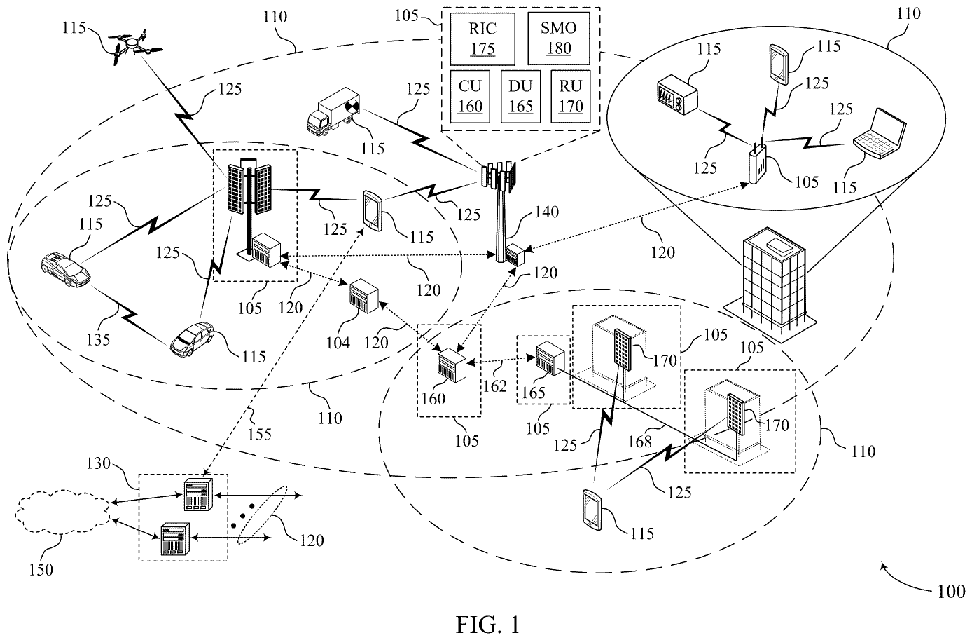

FIG. 1 shows an example of a wireless communications system 100 that supports closed-loop uplink power control techniques in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support closed-loop uplink power control techniques in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with various aspects, one or more UEs 115 may be configured with a unified PHR report format may provide for transmission of a PHR report that indicates a first quantity (e.g., Y) of downlink pathloss measurements for a first quantity (e.g., Y) of configured downlink pathloss reference signals, a second quantity (e.g., X) of accumulated closed loop power values for the first quantity of configured power control loops, and an indication of the UE P_{CMAX}. In some aspects, the PHR report may be flexibly configured for multiple different pathloss reference signals (e.g., one or more of PUSCH, PUCCH, SRS, or PRACH), and for one or two separate power control loops. In some aspects, a UE 115 may be configured with a single pathloss reference signal (e.g., a CSI-RS), and either one or two power control loops. In some aspects, different uplink channels may be associated with one or more power control loops, which may provide flexible power control configurations. Additionally, or alternatively, a UE 115 may be configured to transmit multiple PHR reports that include different parameters, such as a first PHR report that provides the first quantity of downlink pathloss measurements, a second PHR report that provides the second quantity of accumulated closed loop power values, and a third PHR report that provides P_{CMAX}. In some aspects, the different PHR reports may be transmitted at different periodicities, in accordance with different rates of change for each of the associated values.

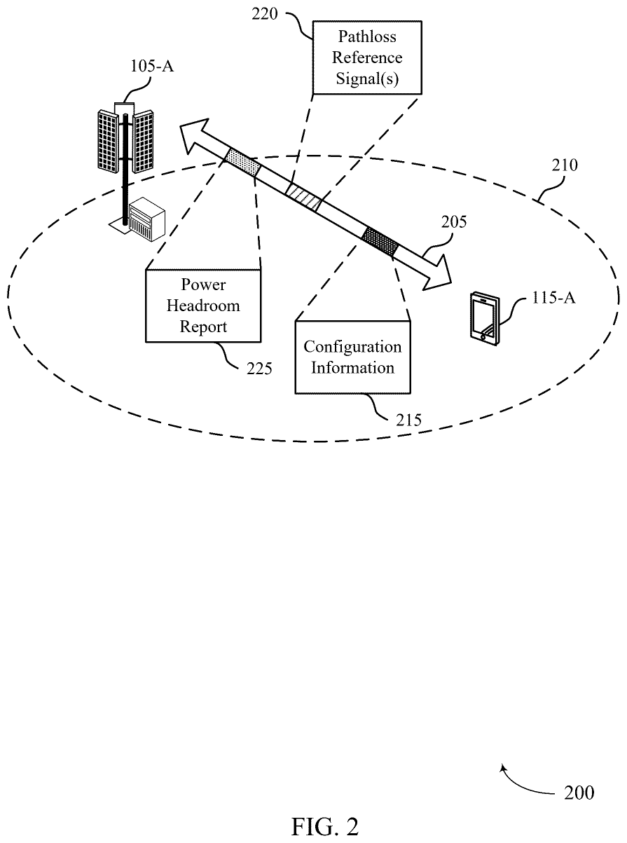

FIG. 2 shows an example of a wireless communications system 200 that supports closed-loop uplink power control techniques in wireless communications in accordance with one or more aspects of the present disclosure. The wireless communications system 200 may implement or be implemented by aspects of the wireless communications system 100 described with reference to FIG. 1. For example, the wireless communications system 200 illustrates a network entity 105-a and a UE 115-a, which may represent examples of corresponding devices as described with reference to FIG. 1. For example, the network entity 105-a and the UE 115-b may communicate with one another via one or more communications channels 205 and one or more corresponding cells 210.

In accordance with various aspects discussed herein, the network entity 105-a may transmit a configuration information 215 to the UE 115-a to configure one or more pathloss reference signals 220, and to configure a format for a PHR report 225 that is to be transmitted by the UE 115-a. In some aspects, the configuration information 215 may indicate, configure, or activate the one or more pathloss reference signals 220. In some aspects, the one or more pathloss reference signals may include a first pathloss reference signal associated with one or more of an uplink shared channel (e.g., PUSCH), an uplink control channel (e.g. PUCCH), an uplink reference signal (e.g., SRS), or an uplink random access channel (e.g. PRACH). Further, in some aspects, one or more of a second, third, or fourth pathloss reference signal may be configured that are associated with one or more of the uplink shared channel, uplink control channel, uplink reference signal, or uplink random access channel.

In some aspects, a single closed-loop power control loop may be associated with uplink transmissions for one or more of the uplink shared channel, uplink control channel, uplink reference signal, or uplink random access channel. Given the purpose of closed-loop power control is identifying a variation of physical over-the-air channel (e.g., between the UE 115-a and network entity 105-a) in time, a single closed-loop for multiple types of uplink transmissions (e.g., including PUCCH, PUSCH, SRS, and PRACH) regardless of the transmission channel or signal type may provide for reduced latency in such identifications across transmission types. In some cases, different uplink transmissions may use different transmit powers due to different decoding signal to noise ratios (SNRs) at the receiver, and thus uplink control channel, shared channel, reference signal, and random access transmissions may use different transmit powers (e.g., with a constant power offset). In order to accommodate for the power differences, different open loop initial power values may be associated with different types of uplink transmissions (e.g., different P_{O} values), and the uplink transmit power of the UE 115-a may be determined in accordance with the following equations:

$$\text{?} ( i , j , \text{?} , l ) = min \{ \begin{matrix}\text{?} ( i ) , \\ \text{?} ( j ) + 10 {log}_{10} ( \text{?} \cdot \text{?} ( i ) ) + \text{?} ( j ) \cdot \\ \text{?} ( \text{?} ) + \text{?} ( i ) + {u}_{b , f , c} ( i )\end{matrix} \} [ dBm ] ,$$

$$\text{?} ( i , \text{?} , \text{?} , l ) = min \{ \begin{matrix}\text{?} ( i ) , \\ \text{?} ( \text{?} ) + 10 {log}_{10} ( \text{?} \cdot \text{?} ( i ) ) + \text{?} ( \text{?} ) + \\ \text{?} ( F ) + \text{?} ( i ) + {u}_{b , f , c} ( i )\end{matrix} \} [ dBm ] ,$$

$$and$$

$$\text{?} ( i , \text{?} , l ) = min \{ \begin{matrix}\text{?} ( i ) , \\ \text{?} ( \text{?} ) + 10 {log}_{10} ( \text{?} \cdot \text{?} ( i ) ) + \text{?} ( \text{?} ) \cdot \\ \text{?} ( \text{?} ) + {u}_{b , f , c} ( i )\end{matrix} \} [ dBm ] ,$$

$$\text{?} \text{indicates text missing or illegible when filed}$$

where the P_{O} values correspond to a target base receive power for the network entity 105-a, the term

$$10 {log}_{10} ( {2}^{μ} \cdot {M}_{X}^{X} ( i ) )$$

corresponds to a resource block (RB) factor, the term “ . . . PL . . . ” corresponds to a pathloss factor, the “Δ” term corresponds to a modulation and coding scheme (MCS) factor, and the term “u_{b,f,c}(i)” corresponds to a unified single closed-loop power control. Such a unified single closed-loop power control may simplify implementation of power control loop management at the UE 115-a, and may also enhance performance by allowing channel variations identified from one channel to be applied to other channels.

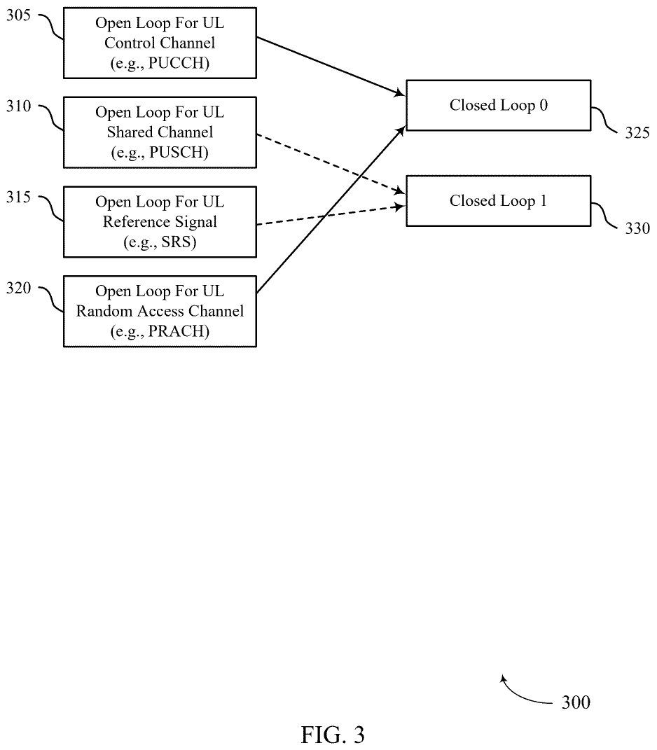

FIG. 3 shows an example of a power control channel mapping 300 that supports closed-loop uplink power control techniques in wireless communications in accordance with one or more aspects of the present disclosure. The power control channel mapping 300 may implement or be implemented by aspects of the wireless communications systems 100 and 200 described with reference to FIGS. 1-2. For example, the power control channel mapping 300 illustrates an example mapping of uplink channels to closed loop power control loops.

In some aspects, a network entity may configure up to a maximum number of closed-loop power control loops (e.g., X=1, 2, or 4, up to a maximum number of 4). In some examples, a single closed loop power control loop may be a default configuration. Each uplink transmission of a UE may be linked to a closed-loop power control loop index. Multiple UL transmissions can link to a same closed-loop index. In the example of FIG. 3, a first closed-loop power control loop 325 may be associated with an uplink control channel 305 (e.g., a PUCCH) and an uplink random access channel 320 (e.g., PRACH), and a second closed-loop power control loop 330 may be associated with an uplink shared channel 310 (e.g., a PUSCH) and an uplink reference signal 315 (e.g., SRS). In some aspects, multiple uplink transmissions may link to a same closed loop index. For example, PUCCH format 0, 1, and 4 may share a same loop index (e.g., loop index 0), and PUCCH format 2 and 3, and PUSCH, may share a same loop index (e.g., loop index 1). Such an example may provide power control loops where PUCCH format 0, 1, and 4 support multi-user communications e(e.g., multiple UEs in a same RB), and in such cases inter-UE interference may be controlled more carefully and thus a separate power control may be used than for PUCCH formats 2 and 3, which do not support multi-user. In some aspects, configuration information may be provided (e.g., via RRC signaling) that indicates of the linkage between uplink transmissions (or transmission types) and a corresponding closed-loop index. In aspects where a default configuration is used with a single closed-loop, such indications may not be provided.

In some aspects, with a single unified closed-loop power control, multiple PHR types may not be defined, and one PHR type may be sufficient. In such aspects, a PHR report may include information related to pathloss measurements, accumulated power values (e.g., an accumulated value of transmit power control (TPC) commands that are received at the UE), and the UE maximum transmit power (e.g., P_{CMAX}). is enough. In some aspects, pathloss measurements may be provided for each configured downlink pathloss measurement signal. For example, Y downlink pathloss measurements may be reported from Y configured downlink pathloss reference signals (e.g., where a pathloss reference signal may be associated with one or more of PUSCH, PUCCH, SRS, or PRACH). Further, the accumulated power value for each closed-loop may be provided in the PHR report. For example, if a network entity configures a UE with X closed-loops, then each PHR may report X accumulated power values for the X closed-loops. In some aspects, the accumulated power may be provided because there may be a mismatch between a quantity of TPC commands send by the network entity and a quantity of TPC commands received at the UE (e.g., if the UE does not successfully receive downlink control information that contains a TPC command). Additionally, the maximum transmit power of the UE (e.g. P_{CMAX}) may apply across uplink transmission types. Based on the information provided in such a PHR report, a network entity may determine a UE transmit power, and thus determine the power headroom of the UE based on the reported information.

As discussed, such techniques may provide flexibility at the network entity for configuring different pathloss measurement signals, and for configuring different closed-loop power control loops. However, in many cases a single downlink pathloss reference signal, such as a CSI-RS, may be configured at a UE that is common for each of the uplink transmission types, the such UEs just need to report one downlink pathloss measurement. Further, in many cases the network entity may configure a single closed loop. Therefore, in such cases, a UE only need to report one downlink pathloss measurement, one accumulated power value for closed-loop, and one P_{CMAX} value in a PHR report, and thus overhead associated with PHR reporting may be reduced relative to cases where each type of uplink channel and closed loop index is reported separately.

In some aspects, overhead associated with PHR reporting may be further reduced. For example, a report frequency for reported parameters P_{CMAX}, downlink pathloss measurement, and accumulated closed-loop values, may be different. For P_{CMAX}, this parameter may vary relatively slowly, and relatively low frequency reports may be sufficient to provide such information, as a maximum transmit capability normally does not change, or changes slowly with environment temperature, humidity, and the like. For accumulated closed-loop values, this reflects the TPC commands received at a UE to compensate channel fast small scale fading, which changes relatively fast. For downlink pathloss measurements, this information may change with the downlink channel (e.g., in accordance with large scale fading), which may change at a medium rate relative to the rates of change of P_{CMAX} and accumulated closed-loop values. In some aspects, the network entity may be aware of a quantity of TPC commands sent to a UE, and this information in a PHR report may correct any discrepancy due to missed downlink control information at the UE, and the network entity may trigger the UE to provide such information more or less frequently. Additionally, or alternatively, a UE may transmit separate PHR reports for each of the different reported parameters. For example, a UE may be configured to provide report type A for P_{CMAX}, report type B for downlink pathloss measurements, and report type C for accumulated values for closed-loop TPC commands, and the network entity may configured transmission of the different report types at different periodicities, or may trigger the UE to report the different types with different frequencies. In some aspects, the network entity may configure the UE to trigger a PHR when a parameter value associated with the PHR has changed from a prior reported value by a threshold amount.

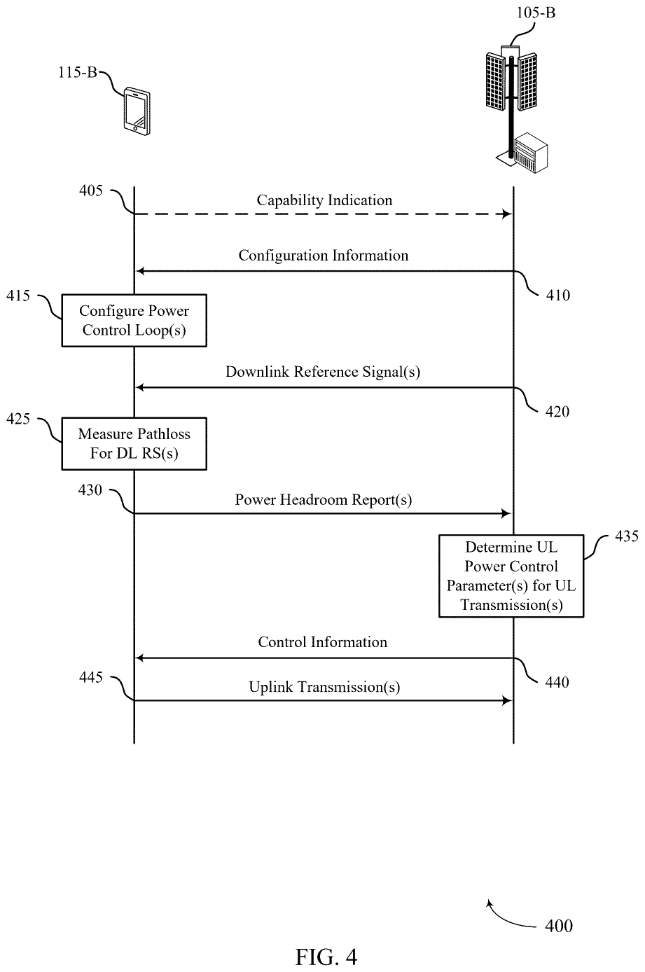

FIG. 4 shows an example of a process flow 400 that supports closed-loop uplink power control techniques in wireless communications in accordance with one or more aspects of the present disclosure. The process flow 400 may implement or be implemented by aspects of the wireless communications systems 100 and 200, or the power control channel mapping 300 described with reference to FIGS. 1-3. For example, the process flow 400 illustrates communications between a UE 115-b and a network entity 105-b, which may represent examples of corresponding devices as described with reference to FIGS. 1-3. In some aspects, the UE 115-b may report power headroom in accordance with a unified PHR configuration.

In the following description of the process flow 400, the operations between the UE 115-b and the network entity 105-b may be performed in different orders or at different times. Some operations may also be left out of the process flow 400, or other operations may be added. Although the UE 115-b and the network entity 105-b are shown performing the operations of the process flow 400, some aspects of some operations may also be performed by one or more other wireless devices.

At 405, optionally, the UE 115-b may transmit, and the network entity 105-b may receive, a capability indication that the UE 115-b can support a unified PHR configuration. In some aspects, the capability indication may be provided in RRC signaling, in a medium access control (MAC) control element (CE), in uplink control information (UCI), or any combination thereof.

At 410, the network entity 105-b may transmit, and the UE 115-b may receive, configuration information that configures PHR reporting. In some aspects, the configuration information may configure one or more downlink pathloss reference signals, one or more power control loops, or any combination thereof. The configuration information may be transmitted, for example, in RRC signaling, a MAC-CE, downlink control information (DCI), or any combination thereof. In some aspects, the configuration information may provide that PHR reports may include one or more parameters, where different parameters may be reported at different periodicities (e.g., PCMAX may be reported at a first periodicity, downlink pathloss measurements may be reported at a second periodicity, and accumulated closed-loop power control values may be reported at a third periodicity.

At 415, the UE may configure one or more power control loops in accordance with the configuration information. At 420, the network entity 105-b may transmit, and the UE 115-b may receive, one or more downlink reference signals. In some aspects, the downlink reference signals may include CSI-RS transmissions, although other downlink reference signals may be used. At 425 the UE 115-b may measure the pathloss associated with each configured downlink pathloss reference signal.

At 430, the UE 115-b may transmit, and the network entity 105-b may receive, one or more PHR reports. The PHR reports may include one or more of downlink pathloss reference signal measurements, accumulated closed-loop values (e.g., accumulated values of TPC commands), and a P_{CMAX} of the UE 115-b, in accordance with techniques as discussed herein. At 435, the network entity 105-b may determine uplink power control parameters for one or more uplink transmissions of the UE 115-b. At 440, the network entity 105-b may transmit, and the UE 115-b may receive, control information associated with one or more uplink transmissions, where an indicated transmit power is based on the information provided in the PHR report. At 445, the UE 115-b may transmit, and the network entity 105-b may receive, one or more uplink transmissions using an uplink transmit power that is determined in accordance with a unified single closed-loop power control equation as discussed herein.

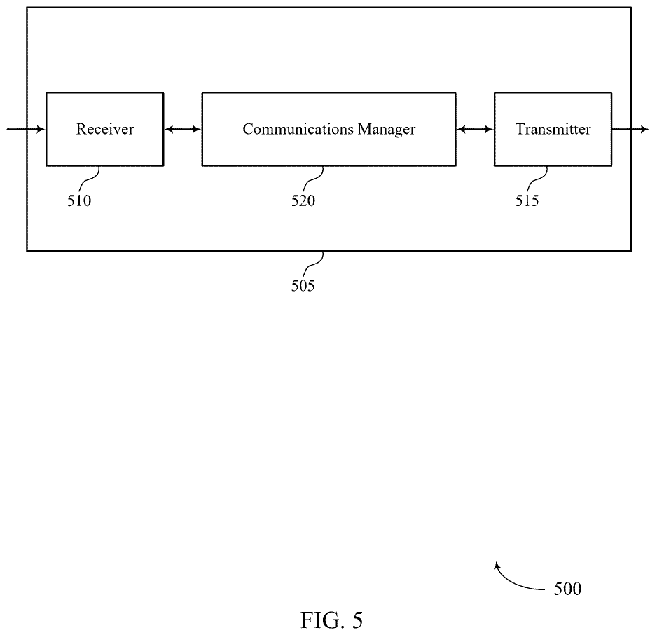

FIG. 5 shows a block diagram 500 of a device 505 that supports closed-loop uplink power control techniques in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to closed-loop uplink power control techniques in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to closed-loop uplink power control techniques in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of closed-loop uplink power control techniques in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The communications manager 520 is capable of, configured to, or operable to support a means for transmitting at least the first power headroom report in accordance with the configuration information.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for a unified PHR report that provides information related to pathloss measurements, accumulated closed loop power values, and maximum transmit power of a UE, which may provide for enhanced reliability of uplink communications through accurate PHR information, reduced latency, improved user experience, and more efficient utilization of communication resources.

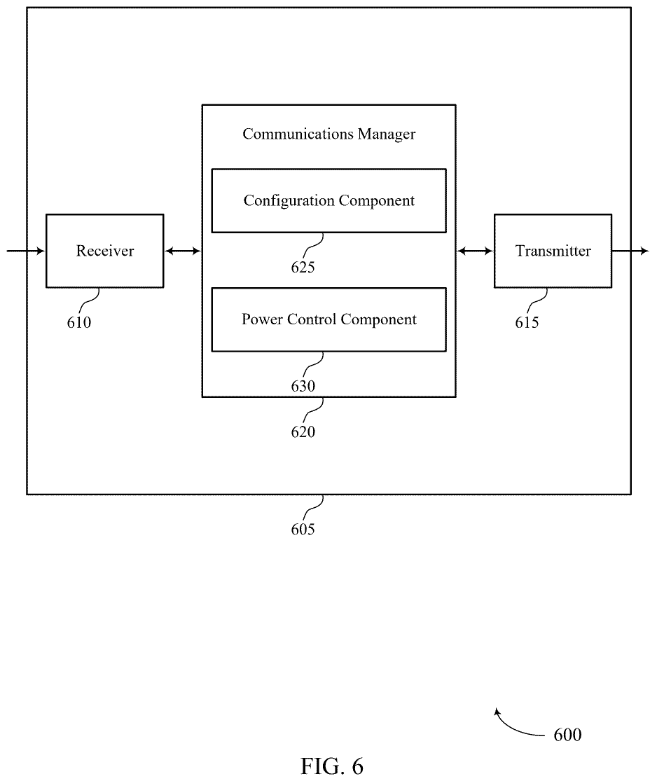

FIG. 6 shows a block diagram 600 of a device 605 that supports closed-loop uplink power control techniques in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to closed-loop uplink power control techniques in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to closed-loop uplink power control techniques in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of closed-loop uplink power control techniques in wireless communications as described herein. For example, the communications manager 620 may include a configuration component 625 a power control component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The power control component 630 is capable of, configured to, or operable to support a means for transmitting at least the first power headroom report in accordance with the configuration information.

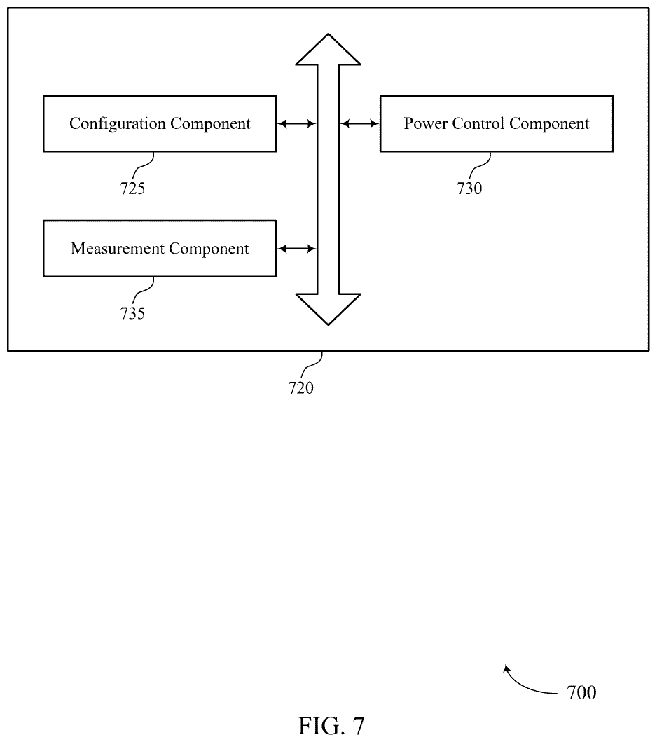

FIG. 7 shows a block diagram 700 of a communications manager 720 that supports closed-loop uplink power control techniques in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of closed-loop uplink power control techniques in wireless communications as described herein. For example, the communications manager 720 may include a configuration component 725, a power control component 730, a measurement component 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The power control component 730 is capable of, configured to, or operable to support a means for transmitting at least the first power headroom report in accordance with the configuration information.

In some examples, a first power control loop of the second quantity of power control loops provides a first closed loop power control function for each of a first set of uplink shared channel transmissions, a first set of uplink control channel transmissions, and a first set of uplink sounding reference signal transmissions. In some examples, a second power control loop of the second quantity of power control loops provides a second closed loop power control function for each of a second set of uplink shared channel transmissions, a second set of uplink control channel transmissions, and a second set of uplink sounding reference signal transmissions. In some examples, the configuration information further indicates that one or both of the first power control loop or the second power control loop are enabled at the UE.

In some examples, the measurement component 735 is capable of, configured to, or operable to support a means for measuring a downlink pathloss for each pathloss reference signal of the first quantity of pathloss reference signals, where each pathloss reference signal is associated with one or more of an uplink shared channel, an uplink control channel, an uplink sounding reference signal, or a random access channel, and where the first power headroom report includes a measured downlink pathloss for each pathloss reference signal.

In some examples, the power control component 730 is capable of, configured to, or operable to support a means for determining the second quantity of accumulated closed loop power values associated with each power control loop of the second quantity of power control loops as a sum of received power increment values and power decrement values received in one or more transmit power control commands associated with each respective power control loop. In some examples, the first power headroom report includes information for each of the first quantity of pathloss measurements, the second quantity of accumulated closed loop power values, and the maximum transmit power of the UE.

In some examples, the first power headroom report indicates each of the first quantity of pathloss measurements, and the power control component 730 is capable of, configured to, or operable to support a means for transmitting a second power headroom report in accordance with the configuration information that indicates the second quantity of accumulated closed loop power values. In some examples, the first power headroom report indicates each of the first quantity of pathloss measurements, and the power control component 730 is capable of, configured to, or operable to support a means for transmitting a third power headroom report in accordance with the configuration information that indicates the maximum transmit power of the UE. In some examples, the first power headroom report, the second power headroom report, and the third power headroom report are transmitted at different periodicities.

In some examples, the power control component 730 is capable of, configured to, or operable to support a means for receiving a trigger to transmit the first power headroom report, and where the first power headroom report is transmitted in response to the trigger. In some examples, to support receiving the trigger to transmit the first power headroom report, the power control component 730 is capable of, configured to, or operable to support a means for detecting that a parameter value associated with the first power headroom report has changed from a prior reported value by a threshold amount.

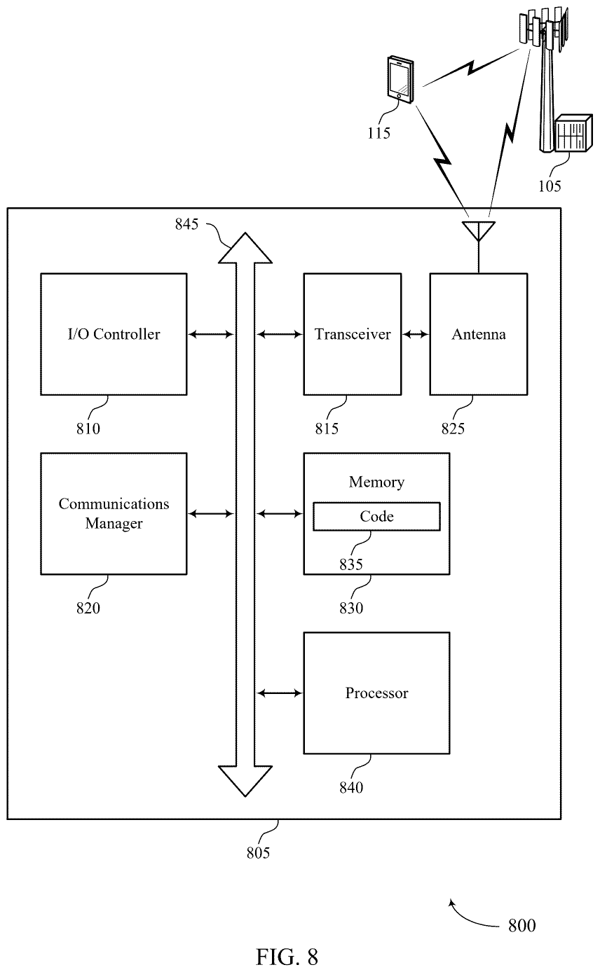

FIG. 8 shows a diagram of a system 800 including a device 805 that supports closed-loop uplink power control techniques in wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting closed-loop uplink power control techniques in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The communications manager 820 is capable of, configured to, or operable to support a means for transmitting at least the first power headroom report in accordance with the configuration information.

By including or configuring the communications manager 820 in accordance with examples as described herein, the device 805 may support techniques for a unified PHR report that provides information related to pathloss measurements, accumulated closed loop power values, and maximum transmit power of a UE, which may provide for enhanced reliability of uplink communications through accurate PHR information, reduced latency, improved user experience, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of closed-loop uplink power control techniques in wireless communications as described herein, or the at least one processor 840 and the at least one memory 830 may be otherwise configured to, individually or collectively, perform or support such operations.

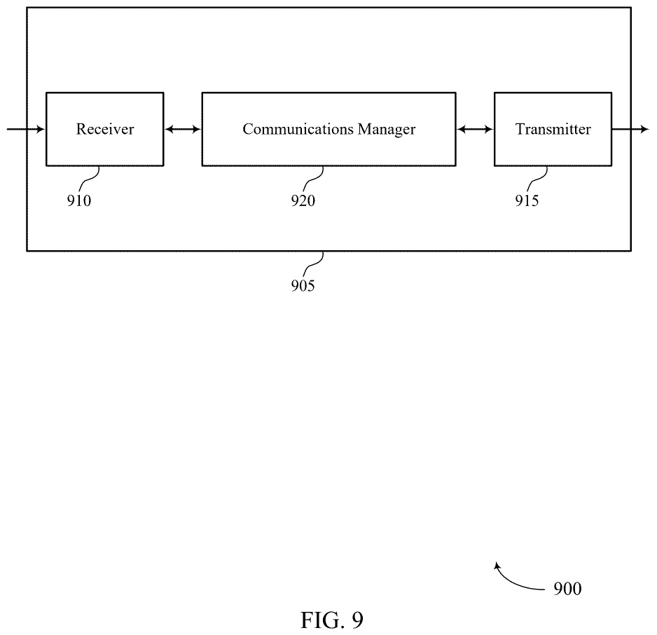

FIG. 9 shows a block diagram 900 of a device 905 that supports closed-loop uplink power control techniques in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of closed-loop uplink power control techniques in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE. The communications manager 920 is capable of, configured to, or operable to support a means for obtaining at least the first power headroom report in accordance with the configuration information. The communications manager 920 is capable of, configured to, or operable to support a means for outputting control information for one or more uplink transmissions of the UE that includes a power control parameter that is based on the first power headroom report.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for a unified PHR report that provides information related to pathloss measurements, accumulated closed loop power values, and maximum transmit power of a UE, which may provide for enhanced reliability of uplink communications through accurate PHR information, reduced latency, improved user experience, and more efficient utilization of communication resources.

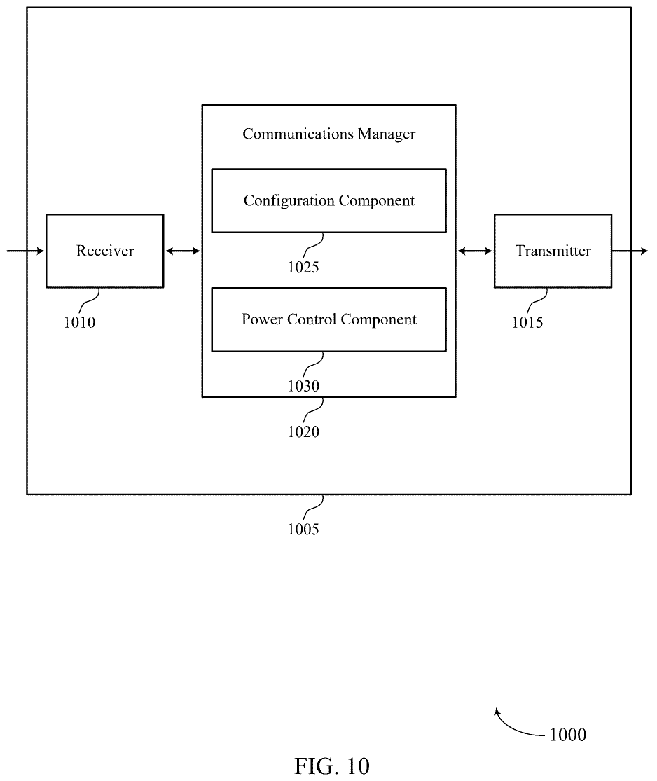

FIG. 10 shows a block diagram 1000 of a device 1005 that supports closed-loop uplink power control techniques in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of closed-loop uplink power control techniques in wireless communications as described herein. For example, the communications manager 1020 may include a configuration component 1025 a power control component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE. The power control component 1030 is capable of, configured to, or operable to support a means for obtaining at least the first power headroom report in accordance with the configuration information. The power control component 1030 is capable of, configured to, or operable to support a means for outputting control information for one or more uplink transmissions of the UE that includes a power control parameter that is based on the first power headroom report.

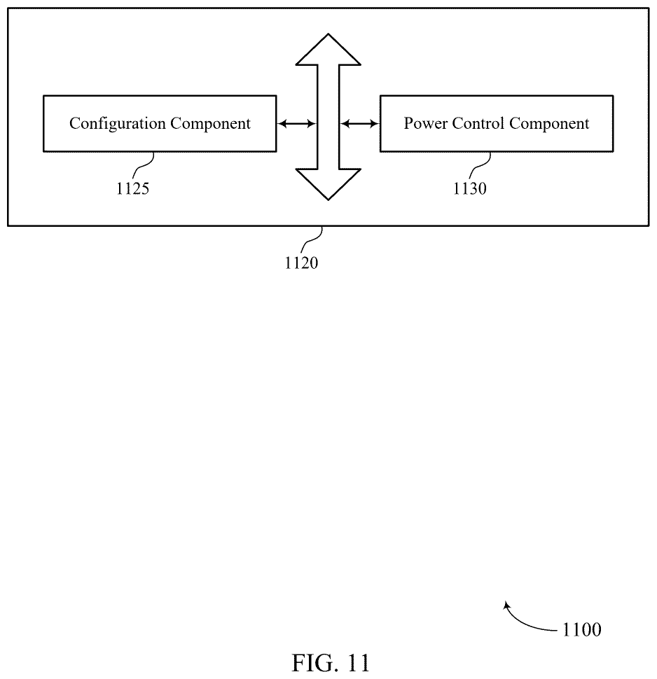

FIG. 11 shows a block diagram 1100 of a communications manager 1120 that supports closed-loop uplink power control techniques in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of closed-loop uplink power control techniques in wireless communications as described herein. For example, the communications manager 1120 may include a configuration component 1125 a power control component 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration component 1125 is capable of, configured to, or operable to support a means for outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE. The power control component 1130 is capable of, configured to, or operable to support a means for obtaining at least the first power headroom report in accordance with the configuration information. In some examples, the power control component 1130 is capable of, configured to, or operable to support a means for outputting control information for one or more uplink transmissions of the UE that includes a power control parameter that is based on the first power headroom report.

In some examples, a first power control loop of the second quantity of power control loops provides a first closed loop power control function for each of a first set of uplink shared channel transmissions, a first set of uplink control channel transmissions, and a first set of uplink sounding reference signal transmissions. In some examples, a second power control loop of the second quantity of power control loops provides a second closed loop power control function for each of a second set of uplink shared channel transmissions, a second set of uplink control channel transmissions, and a second set of uplink sounding reference signal transmissions. In some examples, the configuration information further indicates that one or both of the first power control loop or the second power control loop are enabled at the UE.

In some examples, the first power headroom report includes a measured a downlink pathloss for each pathloss reference signal of the first quantity of pathloss reference signals, where each pathloss reference signal is associated with one or more of an uplink shared channel, an uplink control channel, an uplink sounding reference signal, or a random access channel.

In some examples, the second quantity of accumulated closed loop power values are associated with each power control loop of the second quantity of power control loops, and indicate a sum of power increment values and power decrement values provided to the UE in one or more transmit power control commands associated with each respective power control loop. In some examples, the first power headroom report includes information for each of the first quantity of pathloss measurements, the second quantity of accumulated closed loop power values, and the maximum transmit power of the UE.

In some examples, the first power headroom report indicates each of the first quantity of pathloss measurements, and the power control component 1130 is capable of, configured to, or operable to support a means for obtaining a second power headroom report in accordance with the configuration information that indicates the second quantity of accumulated closed loop power values. In some examples, the first power headroom report indicates each of the first quantity of pathloss measurements, and the power control component 1130 is capable of, configured to, or operable to support a means for obtaining a third power headroom report in accordance with the configuration information that indicates the maximum transmit power of the UE. In some examples, the first power headroom report, the second power headroom report, and the third power headroom report are transmitted at different periodicities.

In some examples, the configuration component 1125 is capable of, configured to, or operable to support a means for configuring a trigger for the UE to transmit the first power headroom report, and where the first power headroom report is transmitted in response to the trigger. In some examples, the trigger includes a parameter value associated with the first power headroom report that has changed from a prior reported value by a threshold amount.

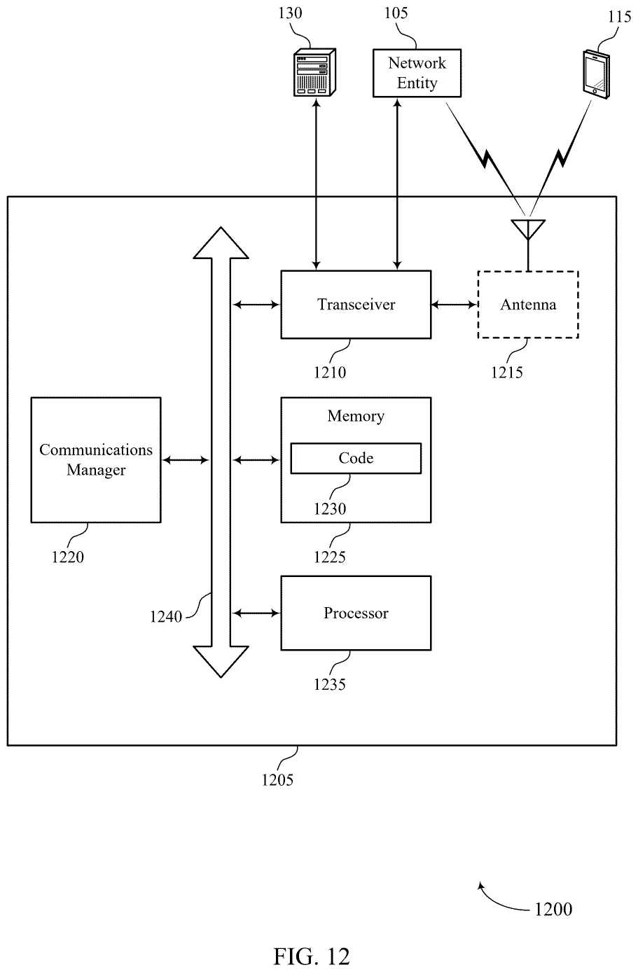

FIG. 12 shows a diagram of a system 1200 including a device 1205 that supports closed-loop uplink power control techniques in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting closed-loop uplink power control techniques in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE. The communications manager 1220 is capable of, configured to, or operable to support a means for obtaining at least the first power headroom report in accordance with the configuration information. The communications manager 1220 is capable of, configured to, or operable to support a means for outputting control information for one or more uplink transmissions of the UE that includes a power control parameter that is based on the first power headroom report.

By including or configuring the communications manager 1220 in accordance with examples as described herein, the device 1205 may support techniques for a unified PHR report that provides information related to pathloss measurements, accumulated closed loop power values, and maximum transmit power of a UE, which may provide for enhanced reliability of uplink communications through accurate PHR information, reduced latency, improved user experience, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of closed-loop uplink power control techniques in wireless communications as described herein, or the at least one processor 1235 and the at least one memory 1225 may be otherwise configured to, individually or collectively, perform or support such operations.

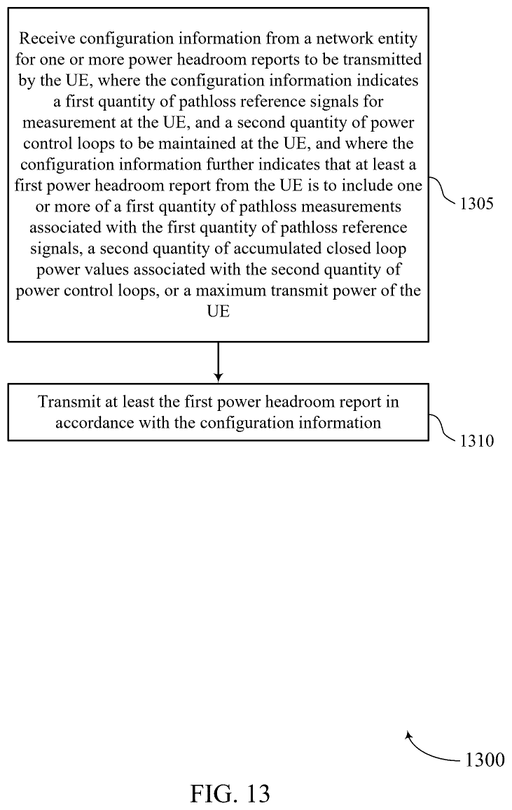

FIG. 13 shows a flowchart illustrating a method 1300 that supports closed-loop uplink power control techniques in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The operations of 1305 may be performed in accordance with examples as disclosed herein. In some examples, aspects of the operations of 1305 may be performed by a configuration component 725 as described with reference to FIG. 7.

At 1310, the method may include transmitting at least the first power headroom report in accordance with the configuration information. The operations of 1310 may be performed in accordance with examples as disclosed herein. In some examples, aspects of the operations of 1310 may be performed by a power control component 730 as described with reference to FIG. 7.

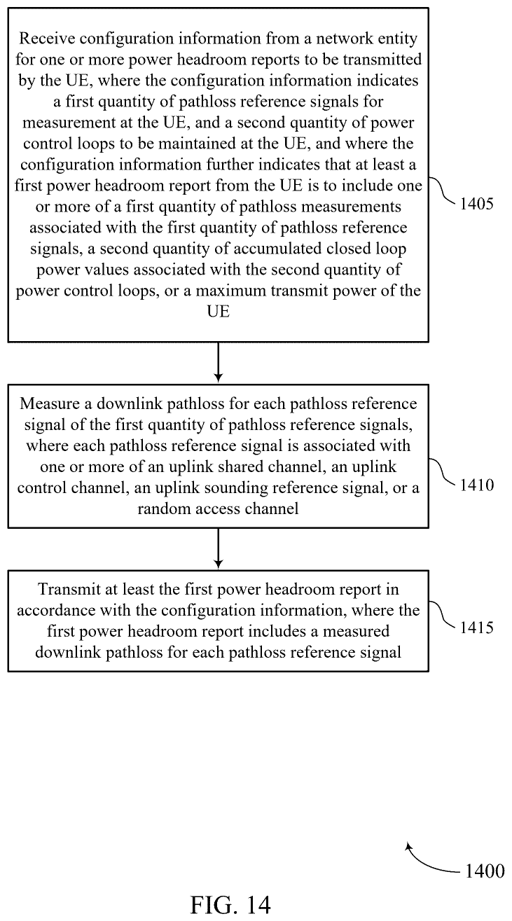

FIG. 14 shows a flowchart illustrating a method 1400 that supports closed-loop uplink power control techniques in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The operations of 1405 may be performed in accordance with examples as disclosed herein. In some examples, aspects of the operations of 1405 may be performed by a configuration component 725 as described with reference to FIG. 7.

At 1410, the method may include measuring a downlink pathloss for each pathloss reference signal of the first quantity of pathloss reference signals, where each pathloss reference signal is associated with one or more of an uplink shared channel, an uplink control channel, an uplink sounding reference signal, or a random access channel. The operations of 1410 may be performed in accordance with examples as disclosed herein. In some examples, aspects of the operations of 1410 may be performed by a measurement component 735 as described with reference to FIG. 7.

At 1415, the method may include transmitting at least the first power headroom report in accordance with the configuration information, where the first power headroom report includes a measured downlink pathloss for each pathloss reference signal. The operations of 1415 may be performed in accordance with examples as disclosed herein. In some examples, aspects of the operations of 1415 may be performed by a power control component 730 as described with reference to FIG. 7.

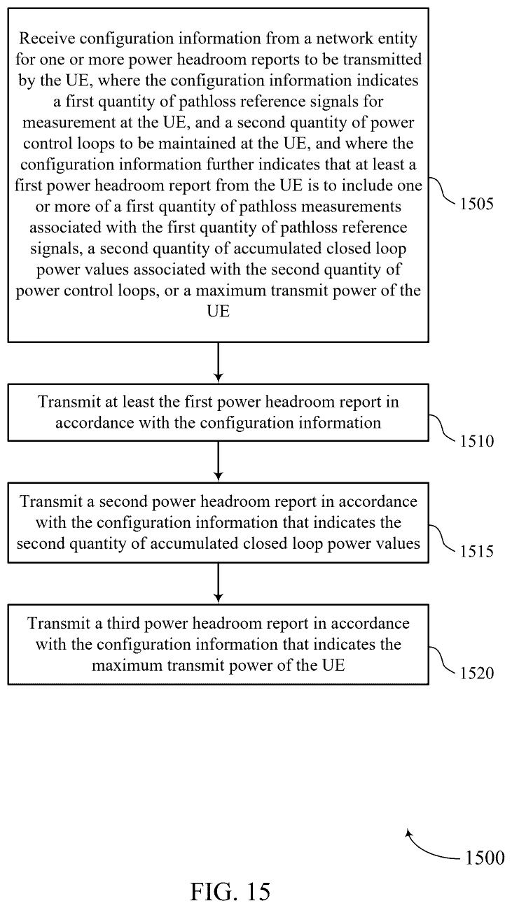

FIG. 15 shows a flowchart illustrating a method 1500 that supports closed-loop uplink power control techniques in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving configuration information from a network entity for one or more power headroom reports to be transmitted by the UE, where the configuration information indicates a first quantity of pathloss reference signals for measurement at the UE, and a second quantity of power control loops to be maintained at the UE, and where the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE. The operations of 1505 may be performed in accordance with examples as disclosed herein. In some examples, aspects of the operations of 1505 may be performed by a configuration component 725 as described with reference to FIG. 7.

At 1510, the method may include transmitting at least the first power headroom report in accordance with the configuration information. The operations of 1510 may be performed in accordance with examples as disclosed herein. In some examples, aspects of the operations of 1510 may be performed by a power control component 730 as described with reference to FIG. 7.

At 1515, the method may include transmitting a second power headroom report in accordance with the configuration information that indicates the second quantity of accumulated closed loop power values. The operations of 1515 may be performed in accordance with examples as disclosed herein. In some examples, aspects of the operations of 1515 may be performed by a power control component 730 as described with reference to FIG. 7.

At 1520, the method may include transmitting a third power headroom report in accordance with the configuration information that indicates the maximum transmit power of the UE. The operations of 1520 may be performed in accordance with examples as disclosed herein. In some examples, aspects of the operations of 1520 may be performed by a power control component 730 as described with reference to FIG. 7.

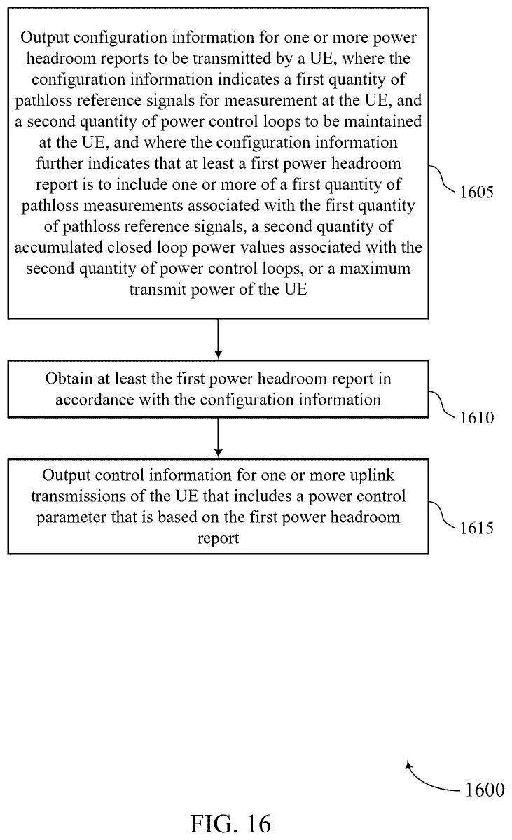

FIG. 16 shows a flowchart illustrating a method 1600 that supports closed-loop uplink power control techniques in wireless communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE. The operations of 1605 may be performed in accordance with examples as disclosed herein. In some examples, aspects of the operations of 1605 may be performed by a configuration component 1125 as described with reference to FIG. 11.

At 1610, the method may include obtaining at least the first power headroom report in accordance with the configuration information. The operations of 1610 may be performed in accordance with examples as disclosed herein. In some examples, aspects of the operations of 1610 may be performed by a power control component 1130 as described with reference to FIG. 11.

At 1615, the method may include outputting control information for one or more uplink transmissions of the UE that includes a power control parameter that is based on the first power headroom report. The operations of 1615 may be performed in accordance with examples as disclosed herein. In some examples, aspects of the operations of 1615 may be performed by a power control component 1130 as described with reference to FIG. 11.

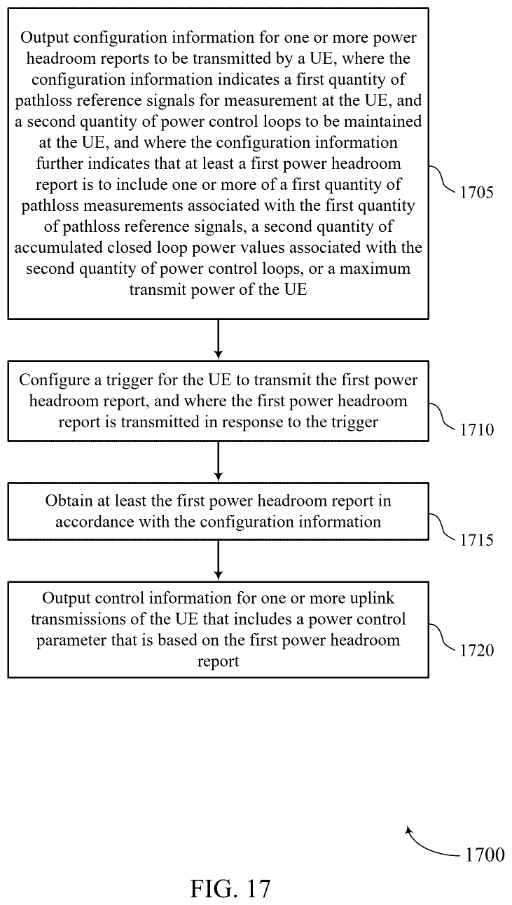

FIG. 17 shows a flowchart illustrating a method 1700 that supports closed-loop uplink power control techniques in wireless communications in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting configuration information for one or more power headroom reports to be transmitted by a UE, where the configuration information indicates a first quantity of pathloss reference signals for measurement at the UE, and a second quantity of power control loops to be maintained at the UE, and where the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE. The operations of 1705 may be performed in accordance with examples as disclosed herein. In some examples, aspects of the operations of 1705 may be performed by a configuration component 1125 as described with reference to FIG. 11.

At 1710, the method may include configuring a trigger for the UE to transmit the first power headroom report, and where the first power headroom report is transmitted in response to the trigger. The operations of 1710 may be performed in accordance with examples as disclosed herein. In some examples, aspects of the operations of 1710 may be performed by a configuration component 1125 as described with reference to FIG. 11.

At 1715, the method may include obtaining at least the first power headroom report in accordance with the configuration information. The operations of 1715 may be performed in accordance with examples as disclosed herein. In some examples, aspects of the operations of 1715 may be performed by a power control component 1130 as described with reference to FIG. 11.

At 1720, the method may include outputting control information for one or more uplink transmissions of the UE that includes a power control parameter that is based on the first power headroom report. The operations of 1720 may be performed in accordance with examples as disclosed herein. In some examples, aspects of the operations of 1720 may be performed by a power control component 1130 as described with reference to FIG. 11.

The following provides an overview of aspects of the present disclosure:
Aspect 1: A method for wireless communications at a UE, comprising: receiving configuration information from a network entity for one or more power headroom reports to be transmitted by the UE, wherein the configuration information indicates a first quantity of pathloss reference signals for measurement at the UE, and a second quantity of power control loops to be maintained at the UE, and wherein the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE; and transmitting at least the first power headroom report in accordance with the configuration information.
Aspect 2: The method of aspect 1, wherein a first power control loop of the second quantity of power control loops provides a first closed loop power control function for each of a first set of uplink shared channel transmissions, a first set of uplink control channel transmissions, and a first set of uplink sounding reference signal transmissions, and a second power control loop of the second quantity of power control loops provides a second closed loop power control function for each of a second set of uplink shared channel transmissions, a second set of uplink control channel transmissions, and a second set of uplink sounding reference signal transmissions.
Aspect 3: The method of aspect 2, wherein the configuration information further indicates that one or both of the first power control loop or the second power control loop are enabled at the UE.
Aspect 4: The method of any of aspects 1 through 3, further comprising: measuring a downlink pathloss for each pathloss reference signal of the first quantity of pathloss reference signals, wherein each pathloss reference signal is associated with one or more of an uplink shared channel, an uplink control channel, an uplink sounding reference signal, or a random access channel, and wherein the first power headroom report includes a measured downlink pathloss for each pathloss reference signal.
Aspect 5: The method of any of aspects 1 through 4, further comprising: determining the second quantity of accumulated closed loop power values associated with each power control loop of the second quantity of power control loops as a sum of received power increment values and power decrement values received in one or more transmit power control commands associated with each respective power control loop.
Aspect 6: The method of any of aspects 1 through 5, wherein the first power headroom report includes information for each of the first quantity of pathloss measurements, the second quantity of accumulated closed loop power values, and the maximum transmit power of the UE.
Aspect 7: The method of any of aspects 1 through 6, wherein the first power headroom report indicates each of the first quantity of pathloss measurements, and wherein the method further comprises: transmitting a second power headroom report in accordance with the configuration information that indicates the second quantity of accumulated closed loop power values; and transmitting a third power headroom report in accordance with the configuration information that indicates the maximum transmit power of the UE.
Aspect 8: The method of aspect 7, wherein the first power headroom report, the second power headroom report, and the third power headroom report are transmitted at different periodicities.
Aspect 9: The method of any of aspects 1 through 8, further comprising: receiving a trigger to transmit the first power headroom report, and wherein the first power headroom report is transmitted in response to the trigger.
Aspect 10: The method of aspect 9, wherein receiving the trigger to transmit the first power headroom report comprises: detecting that a parameter value associated with the first power headroom report has changed from a prior reported value by a threshold amount.
Aspect 11: A method for wireless communications at a network entity, comprising: outputting configuration information for one or more power headroom reports to be transmitted by a UE, wherein the configuration information indicates a first quantity of pathloss reference signals for measurement at the UE, and a second quantity of power control loops to be maintained at the UE, and wherein the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE; obtaining at least the first power headroom report in accordance with the configuration information; and outputting control information for one or more uplink transmissions of the UE that includes a power control parameter that is based at least in part on the first power headroom report.
Aspect 12: The method of aspect 11, wherein a first power control loop of the second quantity of power control loops provides a first closed loop power control function for each of a first set of uplink shared channel transmissions, a first set of uplink control channel transmissions, and a first set of uplink sounding reference signal transmissions, and a second power control loop of the second quantity of power control loops provides a second closed loop power control function for each of a second set of uplink shared channel transmissions, a second set of uplink control channel transmissions, and a second set of uplink sounding reference signal transmissions.
Aspect 13: The method of aspect 12, wherein the configuration information further indicates that one or both of the first power control loop or the second power control loop are enabled at the UE.
Aspect 14: The method of any of aspects 11 through 13, wherein the first power headroom report includes a measured a downlink pathloss for each pathloss reference signal of the first quantity of pathloss reference signals, wherein each pathloss reference signal is associated with one or more of an uplink shared channel, an uplink control channel, an uplink sounding reference signal, or a random access channel.
Aspect 15: The method of any of aspects 11 through 14, wherein the second quantity of accumulated closed loop power values are associated with each power control loop of the second quantity of power control loops, and indicate a sum of power increment values and power decrement values provided to the UE in one or more transmit power control commands associated with each respective power control loop.
Aspect 16: The method of any of aspects 11 through 15, wherein the first power headroom report includes information for each of the first quantity of pathloss measurements, the second quantity of accumulated closed loop power values, and the maximum transmit power of the UE.
Aspect 17: The method of any of aspects 11 through 16, wherein the first power headroom report indicates each of the first quantity of pathloss measurements, and wherein the method further comprises: obtaining a second power headroom report in accordance with the configuration information that indicates the second quantity of accumulated closed loop power values; and obtaining a third power headroom report in accordance with the configuration information that indicates the maximum transmit power of the UE.
Aspect 18: The method of aspect 17, wherein the first power headroom report, the second power headroom report, and the third power headroom report are transmitted at different periodicities.
Aspect 19: The method of any of aspects 11 through 18, further comprising: configuring a trigger for the UE to transmit the first power headroom report, and wherein the first power headroom report is transmitted in response to the trigger.
Aspect 20: The method of aspect 19, wherein the trigger includes a parameter value associated with the first power headroom report that has changed from a prior reported value by a threshold amount.
Aspect 21: A UE for wireless communications, comprising one or more memories storing processor-executable code, and one or more processors coupled with the one or more memories and individually or collectively operable to execute the code to cause the UE to perform a method of any of aspects 1 through 10.
Aspect 22: A UE for wireless communications, comprising at least one means for performing a method of any of aspects 1 through 10.
Aspect 23: A non-transitory computer-readable medium storing code for wireless communications, the code comprising instructions executable by one or more processors to perform a method of any of aspects 1 through 10.
Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.
Aspect 25: A network entity for wireless communications, comprising at least one means for performing a method of any of aspects 11 through 20.
Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information from a network entity for one or more power headroom reports to be transmitted by the UE, wherein the configuration information indicates a first quantity of pathloss reference signals for measurement at the UE, and a second quantity of power control loops to be maintained at the UE, and wherein the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE; and
transmit at least the first power headroom report in accordance with the configuration information.

2. The UE of claim 1, wherein:
a first power control loop of the second quantity of power control loops provides a first closed loop power control function for each of a first set of uplink shared channel transmissions, a first set of uplink control channel transmissions, and a first set of uplink sounding reference signal transmissions, and
a second power control loop of the second quantity of power control loops provides a second closed loop power control function for each of a second set of uplink shared channel transmissions, a second set of uplink control channel transmissions, and a second set of uplink sounding reference signal transmissions.

3. The UE of claim 2, wherein the configuration information further indicates that one or both of the first power control loop or the second power control loop are enabled at the UE.

4. The UE of claim 1, wherein the one or more processors are individually or collectively further operable to execute the code to cause the UE to:
measure a downlink pathloss for each pathloss reference signal of the first quantity of pathloss reference signals, wherein each pathloss reference signal is associated with one or more of an uplink shared channel, an uplink control channel, an uplink sounding reference signal, or a random access channel, and wherein the first power headroom report includes a measured downlink pathloss for each pathloss reference signal.

5. The UE of claim 1, wherein the one or more processors are individually or collectively further operable to execute the code to cause the UE to:
determine the second quantity of accumulated closed loop power values associated with each power control loop of the second quantity of power control loops as a sum of received power increment values and power decrement values received in one or more transmit power control commands associated with each respective power control loop.

6. The UE of claim 1, wherein the first power headroom report includes information for each of the first quantity of pathloss measurements, the second quantity of accumulated closed loop power values, and the maximum transmit power of the UE.

7. The UE of claim 1, wherein the first power headroom report indicates each of the first quantity of pathloss measurements, and the one or more processors are individually or collectively further operable to execute the code to cause the UE to:
transmit a second power headroom report in accordance with the configuration information that indicates the second quantity of accumulated closed loop power values; and
transmit a third power headroom report in accordance with the configuration information that indicates the maximum transmit power of the UE.

8. The UE of claim 7, wherein the first power headroom report, the second power headroom report, and the third power headroom report are transmitted at different periodicities.

9. The UE of claim 1, wherein the one or more processors are individually or collectively further operable to execute the code to cause the UE to:
receive a trigger to transmit the first power headroom report, and wherein the first power headroom report is transmitted in response to the trigger.

10. The UE of claim 9, wherein, to receive the trigger to transmit the first power headroom report, the one or more processors are individually or collectively operable to execute the code to cause the UE to:
detect that a parameter value associated with the first power headroom report has changed from a prior reported value by a threshold amount.

11. A network entity, comprising:
one or more memories storing processor-executable code; and
one or more processors coupled with the one or more memories and individually or collectively operable to execute the code to cause the network entity to:
output configuration information for one or more power headroom reports to be transmitted by a user equipment (UE), wherein the configuration information indicates a first quantity of pathloss reference signals for measurement at the UE, and a second quantity of power control loops to be maintained at the UE, and wherein the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE;
obtain at least the first power headroom report in accordance with the configuration information; and
output control information for one or more uplink transmissions of the UE that includes a power control parameter that is based at least in part on the first power headroom report.

12. The network entity of claim 11, wherein:
a first power control loop of the second quantity of power control loops provides a first closed loop power control function for each of a first set of uplink shared channel transmissions, a first set of uplink control channel transmissions, and a first set of uplink sounding reference signal transmissions, and
a second power control loop of the second quantity of power control loops provides a second closed loop power control function for each of a second set of uplink shared channel transmissions, a second set of uplink control channel transmissions, and a second set of uplink sounding reference signal transmissions.

13. The network entity of claim 12, wherein the configuration information further indicates that one or both of the first power control loop or the second power control loop are enabled at the UE.

14. The network entity of claim 11, wherein the first power headroom report includes a measured a downlink pathloss for each pathloss reference signal of the first quantity of pathloss reference signals, wherein each pathloss reference signal is associated with one or more of an uplink shared channel, an uplink control channel, an uplink sounding reference signal, or a random access channel.

15. The network entity of claim 11, wherein the second quantity of accumulated closed loop power values are associated with each power control loop of the second quantity of power control loops, and indicate a sum of power increment values and power decrement values provided to the UE in one or more transmit power control commands associated with each respective power control loop.

16. The network entity of claim 11, wherein the first power headroom report includes information for each of the first quantity of pathloss measurements, the second quantity of accumulated closed loop power values, and the maximum transmit power of the UE.

17. The network entity of claim 11, wherein the first power headroom report indicates each of the first quantity of pathloss measurements, and the one or more processors are individually or collectively further operable to execute the code to cause the network entity to:
obtain a second power headroom report in accordance with the configuration information that indicates the second quantity of accumulated closed loop power values; and
obtain a third power headroom report in accordance with the configuration information that indicates the maximum transmit power of the UE.

18. The network entity of claim 17, wherein the first power headroom report, the second power headroom report, and the third power headroom report are transmitted at different periodicities.

19. The network entity of claim 11, wherein the one or more processors are individually or collectively further operable to execute the code to cause the network entity to:
configure a trigger for the UE to transmit the first power headroom report, and wherein the first power headroom report is transmitted in response to the trigger.

20. The network entity of claim 19, wherein the trigger includes a parameter value associated with the first power headroom report that has changed from a prior reported value by a threshold amount.

21. A method for wireless communications at a user equipment (UE), comprising:
receiving configuration information from a network entity for one or more power headroom reports to be transmitted by the UE, wherein the configuration information indicates a first quantity of pathloss reference signals for measurement at the UE, and a second quantity of power control loops to be maintained at the UE, and wherein the configuration information further indicates that at least a first power headroom report from the UE is to include one or more of a first quantity of pathloss measurements associated with the first quantity of pathloss reference signals, a second quantity of accumulated closed loop power values associated with the second quantity of power control loops, or a maximum transmit power of the UE; and
transmitting at least the first power headroom report in accordance with the configuration information.

22. The method of claim 21, wherein:
a first power control loop of the second quantity of power control loops provides a first closed loop power control function for each of a first set of uplink shared channel transmissions, a first set of uplink control channel transmissions, and a first set of uplink sounding reference signal transmissions, and
a second power control loop of the second quantity of power control loops provides a second closed loop power control function for each of a second set of uplink shared channel transmissions, a second set of uplink control channel transmissions, and a second set of uplink sounding reference signal transmissions.

23. The method of claim 21, further comprising:
measuring a downlink pathloss for each pathloss reference signal of the first quantity of pathloss reference signals, wherein each pathloss reference signal is associated with one or more of an uplink shared channel, an uplink control channel, an uplink sounding reference signal, or a random access channel, and wherein the first power headroom report includes a measured downlink pathloss for each pathloss reference signal.

24. The method of claim 21, further comprising:
determining the second quantity of accumulated closed loop power values associated with each power control loop of the second quantity of power control loops as a sum of received power increment values and power decrement values received in one or more transmit power control commands associated with each respective power control loop.

25. A method for wireless communications at a network entity, comprising:
outputting configuration information for one or more power headroom reports to be transmitted by a user equipment (UE), wherein the configuration information indicates a first quantity of pathloss reference signals for measurement at the UE, and a second quantity of power control loops to be maintained at the UE, and wherein the configuration information further indicates that at least a first power headroom report is to include one or more of a first quantity of pathloss measurements associated with the first quantity of pathloss reference signals, a second quantity of accumulated closed loop power values associated with the second quantity of power control loops, or a maximum transmit power of the UE;
obtaining at least the first power headroom report in accordance with the configuration information; and
outputting control information for one or more uplink transmissions of the UE that includes a power control parameter that is based at least in part on the first power headroom report.

26. The method of claim 25, wherein:
a first power control loop of the second quantity of power control loops provides a first closed loop power control function for each of a first set of uplink shared channel transmissions, a first set of uplink control channel transmissions, and a first set of uplink sounding reference signal transmissions, and
a second power control loop of the second quantity of power control loops provides a second closed loop power control function for each of a second set of uplink shared channel transmissions, a second set of uplink control channel transmissions, and a second set of uplink sounding reference signal transmissions.

27. The method of claim 25, wherein the first power headroom report includes information for each of the first quantity of pathloss measurements, the second quantity of accumulated closed loop power values, and the maximum transmit power of the UE.

28. The method of claim 25, wherein the first power headroom report indicates each of the first quantity of pathloss measurements, and wherein the method further comprises:
obtaining a second power headroom report in accordance with the configuration information that indicates the second quantity of accumulated closed loop power values; and
obtaining a third power headroom report in accordance with the configuration information that indicates the maximum transmit power of the UE.

29. The method of claim 28, wherein the first power headroom report, the second power headroom report, and the third power headroom report are transmitted at different periodicities.

30. The method of claim 25, further comprising:
configuring a trigger for the UE to transmit the first power headroom report, and wherein the first power headroom report is transmitted in response to the trigger.
